(19) United States
(12) Patent Application Publication
(10) Pub. No.: US 2009/0128423 A1
(43) Pub. Date: May 21, 2009

(54) ANTENNA AND WIRELESS TERMINAL

(75) Inventor: Masatomo MORI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/956,463

(22) Filed: Dec. 14, 2007

(30) Foreign Application Priority Data
Dec. 15, 2006 (JP) 2006-337744

(51) Int. Cl. H01Q 21/00; H01Q 1/22

(52) U.S. Cl. 343/702; 343/893

(57) ABSTRACT

To effectively accommodate a low frequency antenna within various apparatuses, such as a mobile phone, an antenna of a wireless apparatus utilizes a conductor pattern formed on at least one surface of a printed circuit board of the wireless apparatus, a chip antenna mounted on one surface of the printed circuit board connected with the conductor pattern, and a metal plate antenna allocated within an enclosure of the wireless apparatus making a contact with one end of the conductor pattern.

### CROSS-REFERENCE TO RELATED APPLICATIONS

This application is based upon and claims the benefit of priority from the prior Japanese Patent Application No. 2006-337744, filed on Dec. 15, 2006, the entire content of which is incorporated herein by reference.

### TECHNICAL FIELD

The disclosure relates to an antenna and a wireless terminal provided with the antenna. Particularly, the disclosure relates to an antenna structure for wireless communication utilizing low frequency bands in the range of about 10 MHz to 100 MHz, or to a terminal provided with such antenna.

A portable phone/mobile phone may be considered as an example of such terminal. For example, wireless communications based on the communication system such as W-CDMA and CDMA 2000 are presently conducted using such mobile phones. In such wireless communications, audio or data communications are conducted utilizing the radio wave in the frequency bands from several hundred MHz to several GHz, and an antenna used for such communications is provided within an enclosure of the mobile phone.

Particularly, a mobile phone is considered and discussed as an example of a wireless terminal for explanation below, but the present invention is not limited only to such mobile phone.

### BACKGROUND

A mobile phone has been continuously subjected to improvements in performance to provide various excellent functions in recent years. As an example of such functions, a function to transmit and receive programs of the FM broadcast is utilized.

A mobile phone can receive FM broadcast program by additionally providing a FM broadcast receiving unit. Meanwhile, a user of a mobile phone can also have the benefit of music by storing music data into the mobile phone. It is also considered to have the benefit of transmitting music using an external receiving apparatus by transmitting the music data stored in the mobile phone to the external receiving apparatus.

FIG. 8 is a diagram showing an external view of a mobile phone. In FIG. 8, reference numeral 101 denotes an upper enclosure and 102 denotes a lower enclosure. The upper enclosure 101 and the lower enclosure 102 are coupled to rotate with each other through a hinge mechanism 103. Moreover, a built-in antenna 104 is also provided within the mobile phone for the purpose of audio and data communications.

Meanwhile, earphones 105 can be detachably connected to the mobile phone. Use of the earphone 105 enables a user to enjoy music programs stored within the mobile phone. Moreover, a user can also enjoy the FM broadcast using the mobile phone by using such earphones 105 as an antenna for the FM broadcast.

The following is a prior art document describing a conventional wireless terminal.
Publication No. 1997-331209 of the Japanese Laid-Open Patent Application

However, the conventional mobile phone has been accompanied with the following problems.

In the conventional mobile phone, the user has to use earphones to receive the FM broadcast because the earphones are also used as the antenna.

On the other hand, it can also be considered to employ an application for hearing music programs using a speaker provided to the mobile phone. However, if a user desires to enjoy the FM broadcast using such speaker, earphones have to be connected to the mobile phone for reception of the FM broadcast. Therefore, an audio output must be provided for the earphones, and as a result an audio output cannot be obtained for the speaker.

The earphones have to be disconnected from the mobile phone in order to hear the music programs by using the speaker. However, the earphones are necessary for use as an antenna for receiving the FM broadcast. As such reception of the FM broadcast itself becomes impossible without the earphones.

Moreover, in the case of transmitting information by utilizing FM from a mobile phone, information communication to an external receiving apparatus is possible only when the earphones are connected to the mobile phone.

The radio wave in the low-frequency band of about 10 MHz to 100 MHz used for the FM broadcast has ¼ wavelength extended to several meters. However, it is difficult to store an antenna corresponding to such wavelength into an enclosure of a small-size apparatus such as a mobile phone.

Particularly, a mobile phone is increasing improved in the functions therein and tends to be in the trend to allocate various modules such as a variety of circuits, a camera and a speaker within the enclosure. If it is attempted to provide an antenna within the enclosure under the situation explained above, the antenna is likely to interfere with the other electronic components. Moreover, such attempts are a detriment in some cases that the enclosure becomes larger in size in order to accommodate an antenna, and thereby the design of the mobile phone enclosure will be too large, deteriorating the compactness of the mobile phone.

A mobile phone with a folding type enclosure as shown in FIG. 8 is currently conventional. Such a mobile phone is considered to comparatively have an allowance within the space of the enclosure, and can easily attain the mounting space of an antenna relative to a mobile phone with the other type of enclosure. However, the portion within the enclosure at which to mount an antenna may cause a problem.

For example, a user of the mobile phone usually holds a lower enclosure of the folding type mobile phone, due to the design of the mobile phone that a manipulating portion such as numeric keys is provided at the lower enclosure. In the case where an antenna is provided in the lower enclosure, a hand of a user is likely to be placed at the area near the antenna, when a user holds the lower enclosure. If a human body comes sufficiently close to the antenna, antenna impedance will be disturbed, and radiation efficiency of radio waves will be deteriorated and thereby transmission and reception of the FM broadcast are likely to be hindered.

An object is to solve the problems explained above.

### SUMMARY

In view of solving the problems explained above, an antenna disclosed herewith comprises a conductor pattern formed on at least one surface of a printed circuit board of the apparatus, a chip antenna mounted on one surface of the printed circuit board for connection with the conductive pattern, and a metal plate type antenna located accessible in contact with one end of the conductive pattern within the enclosure of the apparatus.

Particularly, the antenna is characterized in that the conductor pattern comprises a first conductor pattern formed on a first surface of the printed circuit board and a second conductor pattern formed on a second surface of the printed circuit board, and one end of the first conductor pattern is connected to one end of the second conductor pattern via a through-hole formed on the printed circuit board.

Moreover, the antenna is characterized in that the conductor pattern is formed on the first surface of the printed circuit board, the chip antenna is located on the second surface of the printed circuit board, and one end of the conductor pattern is connected to one end of the chip antenna via a through-hole formed to the printed circuit board.

Moreover, the antenna is characterized in that one end of the metal plate antenna is formed as a first contact having a spring property, and one end of the conductor pattern is provided with a second contact formed to be in contact with the first contact.

Meanwhile, a terminal disclosed herewith comprises a circuit board for mounting circuits, a conductor pattern formed on the circuit board, a chip antenna mounted on the circuit board and a metal plate antenna constituted with a metal plate and is also characterized in that a built-in antenna is constituted under the condition that the chip antenna, conductor pattern, and metal plate antenna are connected.

Particularly, the terminal is characterized in that the conductor pattern is formed on the first surface of the circuit board, the chip antenna is formed on the second surface of the circuit board, and one end of the conductive pattern is connected to one end of the chip antenna via a through-hole formed to the circuit board.

Moreover, the terminal is characterized in that the conductor pattern comprises the first conductor pattern formed on the first surface of the circuit board and the second conductor pattern formed on the second surface of the circuit board and that the first conductor pattern and the second conductor pattern are connected via the through-hole formed on the circuit board.

Moreover, the terminal is characterized in comprising a first enclosure including a manipulating portion to be manipulated by a user and a second enclosure supported to be freely opened and closed in relation to the first enclosure, wherein the built-in antenna is accommodated within the second enclosure.

Moreover, the terminal is characterized in that the second enclosure is provided with a receiver for outputting audio signal from a communicating party during the communication with the same party and the built-in antenna is located at the area near the location where the receiver is located.

Moreover, the built-in antenna is an antenna for short-wavelength bands.

According to the present disclosure, the antenna can be effectively accommodated in a space of the apparatus. Particularly, the space can be utilized effectively and the effective length of antenna can be approximated to the desired length by constituting the antenna with a plurality of elements and then allocating the same antenna in three-dimensions (to the front and rear surfaces of the substrate or the like).

Moreover, since the antenna can be effectively accommodated within the apparatus, it is no longer required to provide, for example, an external antenna to the outside of the apparatus and the problem in reception of the FM broadcast while the earphones are connected to the apparatus can be eliminated, in comparison with the prior art.

Meanwhile, since the antenna can be accommodated within the apparatus, it is no longer required to provide the built-in antenna corresponding to enlargement in the enclosure and the compactness of the enclosure design is not deteriorated.

Moreover, the possible disturbance of antenna impedance due to a human body is reduced by allocating the antenna to the location of enclosure not held by a user. Accommodation of the antenna to the uppermost part of one enclosure in the apparatus employing the folding type enclosure is a measure for providing the effect of the present invention explained above.

### BRIEF DESCRIPTION OF THE DRAWINGS

FIG. 1 (a) shows an external appearance an embodiment of a mobile phone used under an opened condition.

FIG. 1 (b) shows an external appearance an embodiment of a mobile phone used under a closed condition.

FIG. 2 shows a disassembled perspective view of an upper enclosure of the mobile phone of the embodiment.

FIG. 3 shows a first surface of a printed circuit board of the mobile phone of the embodiment.

FIG. 4 shows a second surface of the printed circuit board of the mobile phone of the embodiment.

FIG. 5 shows a perspective view of a metal plate antenna of the embodiment.

FIG. 6 shows a front elevation of the metal plate antenna of the embodiment.

FIG. 7 shows a state where the metal plate antenna of the embodiment is allocated on the printed circuit board.

FIG. 8 shows an example of a folding type mobile phone.

### DETAILED DESCRIPTION OF THE EMBODIMENT

An embodiment of the present invention will be explained with reference to the accompanying drawings. In the present embodiment, a mobile phone is described as an example of the wireless terminal. However, the present embodiment is not intended to be limited to only mobile phones, but could be applied to other types of wireless terminal devices.

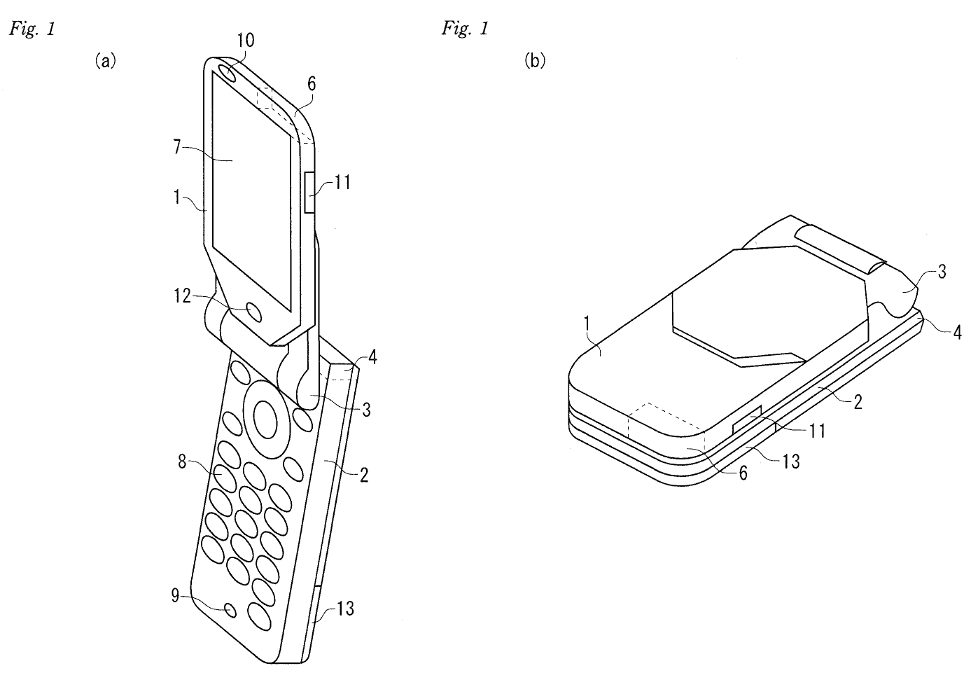

FIG. 1 shows a folding type mobile phone comprising an embodiment of the present invention. FIG. 1(a) shows the mobile phone where a cover is closed. As shown in FIG. 1, the mobile phone of the present embodiment comprises an enclosure divided into an upper enclosure 1 and a lower enclosure 2. These enclosures correspond to a “cover” explained above. The upper enclosure 1 and the lower enclosure 2 are coupled through a hinge 3 for relatively rotating the enclosures to open and close with each other. When the mobile phone is used for a phone call or other kind of communication, the upper enclosure 1 and the lower enclosure 2 are used under the opened condition as shown in FIG. 1(a). When the phone is not in operation, the upper enclosure 1 and the lower enclosure 2 are in the closed condition as shown in FIG. 1(b).

As shown in FIG. 1(a), a liquid crystal display (LCD) 7 for displaying various kinds of information is provided at the rear surface of the upper enclosure 1. Moreover, a receiver 10 is provided at a portion of the upper enclosure above the liquid crystal display 7 in order to receive the audio signal of a communicating party. Meanwhile, speakers 11 are provided at both sides of the upper enclosure 1. These speakers 11 are used to hear the audio signal received from the communicating party, and is also used to hear music programs using the mobile phone. In addition, the upper enclosure 1 is provided with a camera 12 for photographing various images.

The lower enclosure 2 is provided with a manipulating unit 8 including keys used for inputting information such as telephone numbers and characters. Further, a microphone 9 for collecting sounds or voice made during a communication by a user of the mobile phone is also provided at a portion of the lower enclosure 2, below the manipulating unit 8.

A battery 13 for supplying a power source to the mobile phone is provided at the rear surface of the lower enclosure 2, and a main antenna 4 or the like is also provided within the lower enclosure 2. In addition, the mobile phone is provided with various circuits (not illustrated in FIG. 1) for communications.

The main antenna 4 of the mobile phone is a built-in antenna used for audio communications and data communications. In the mobile phone, communications are generally conducted utilizing high frequency bands from several hundreds MHz up to several GHz corresponding to a communication system such as W-CDMA, cdma2000 or the like. The main antenna 4 is provided corresponding to the radio waves in such high frequency bands.

Meanwhile, a low frequency antenna 6 is used for communications using low frequency radio waves of about 10 MHz to 100 MHz as used for the FM broadcast. The mobile phone of the present embodiment comprises a storage unit (not shown) for storing data such as music. In the present embodiment, the mobile phone is capable of applications of transmitting stored data such as music to an external receiving apparatus by using a low-intensity FM transmission, and listing to the music with the external receiving apparatus.

The low frequency antenna 6 of the present embodiment is constituted with a plurality of antenna elements, as explained below. Moreover, in the present embodiment, the low frequency antenna 6 is provided at the uppermost part of the upper enclosure 1, which is near to the receiver 10. The location where the low frequency antenna 6 is provided is an area that a user of the mobile phone rarely holds the phone during operation of the mobile phone.

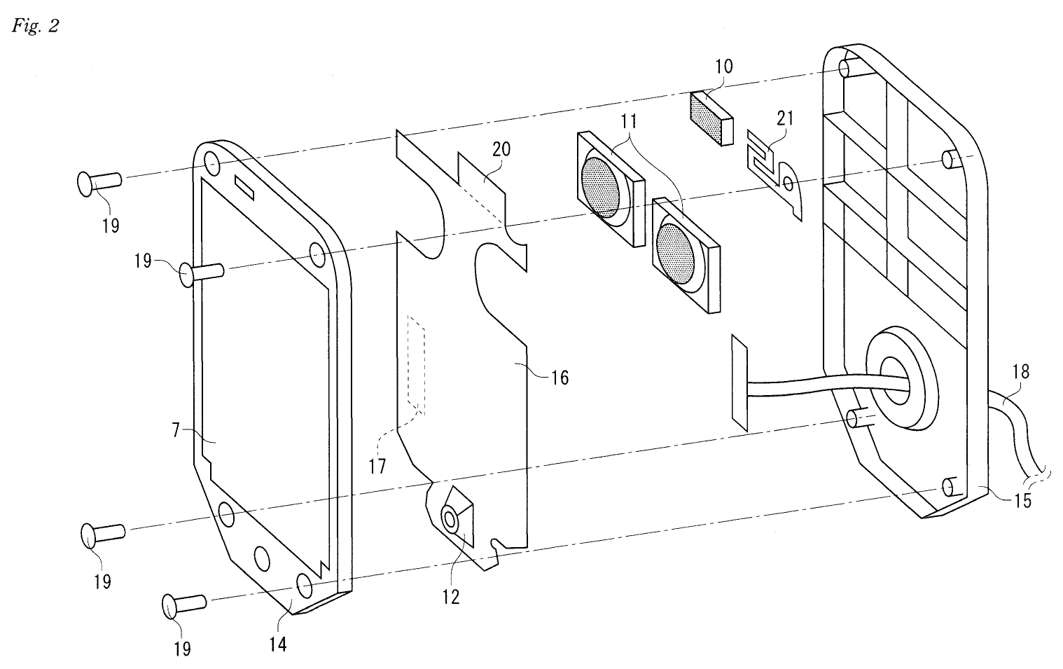

FIG. 2 is a perspective view showing a deconstructed state of the upper enclosure 1 of the mobile phone of the present embodiment. The upper enclosure 1 has a front case 14 and a rear case 15. The front case 14 and the rear case 15 are fixed with screws 19.

A printed circuit board 16 is accommodated within the upper enclosure 1. A camera unit 12 is directly mounted on the printed circuit board 16. Moreover, various circuit elements (not illustrated) are also mounted on the printed circuit board 16. Further, a cable connector 17 is provided on the printed circuit board 16. The cable connector 17 is connected with a coaxial cable 18 extended from the lower enclosure 2, and thereby the circuit in the lower enclosure 2 is connected to the circuit in the upper enclosure 1. A liquid crystal display unit 7 is provided between the front case 14 and the printed circuit board.

Speakers 11 are accommodated within the upper enclosure 1. Speakers 11 are provided one each at both right and left side of the upper enclosure 1, thus a total of two speakers 11 are provided in the upper enclosure 1. In addition, a receiver 10 is accommodated at the upper part of the upper enclosure 1. The liquid crystal display unit 7, the camera unit 12, the speaker 11, and the receiver 10 are respectively connected to the printed circuit board 16, and operations of these units are controlled by the circuits mounted on the printed circuit board 16.

As described above, various components are provided within the upper enclosure 1, and these components must be allocated not to interfere with the other components. Moreover, the low frequency antenna 6 of the present embodiment is additionally mounted in the upper enclosure 1. The low frequency antenna 6 is required to be allocated within the limited space of the upper enclosure 1, ensuring effective length corresponding to the radio wave of the predetermined wavelength, and should not interfere with the other components. Therefore, the low frequency antenna 6 of the present embodiment includes a circuit board antenna 20 and a metal plate antenna 21.

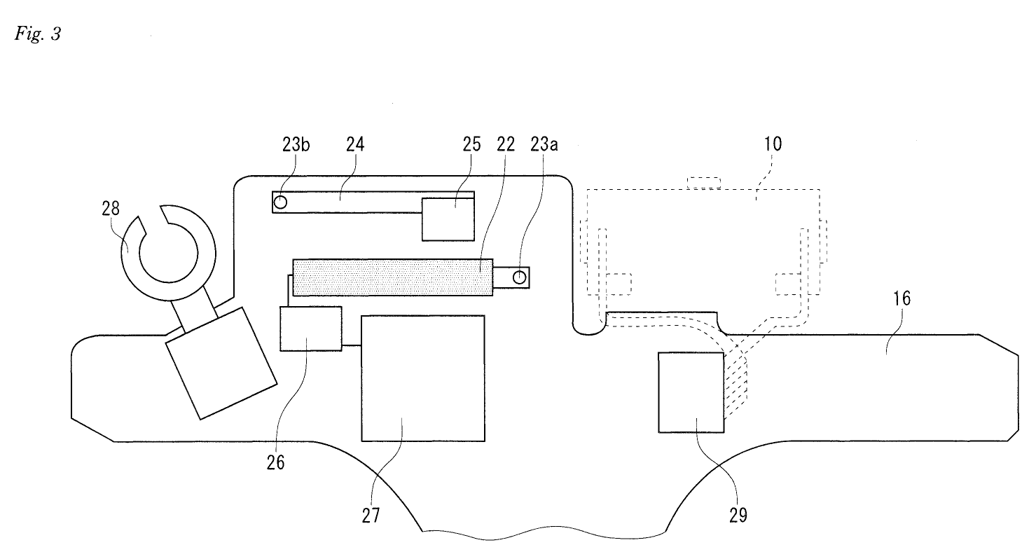

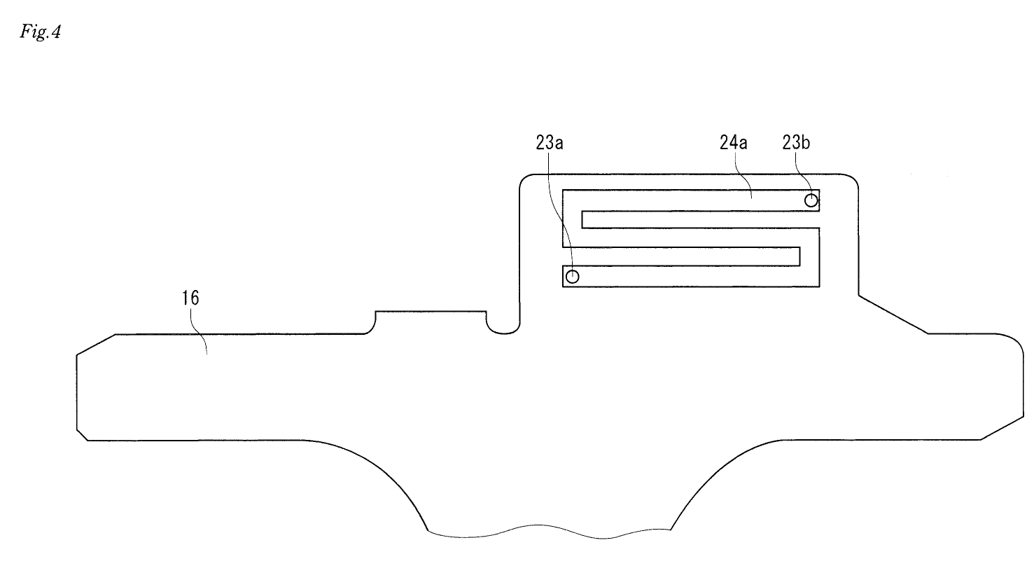

The circuit board antenna 20 is formed at the upper part of the printed circuit board 16 accommodated within the upper enclosure 1 as illustrated. FIG. 3 and FIG. 4 are diagrams showing an enlarged part of the area near the upper part of the printed circuit board 16. FIG. 3 shows one surface of the printed circuit board 16, while FIG. 4 shows the other surface of the printed circuit board 16. At the upper part of the printed circuit board 16, a receiver connector 29 is provided for connection of the receiver 10.

As shown in FIG. 3, a chip antenna 22 is provided on the printed circuit board 16 as the element constituting the circuit board antenna 20. The chip antenna 22 is connected with an FM receiving/transmitting module 27 via a matching circuit 26 for achieving impedance matching. The FM receiving/transmitting module 27 transmits and receives the radio waves through the low frequency antenna 6. Meanwhile, the other end of the chip antenna 22 is connected with a first through-hole 23a provided through the rear surface of the printed circuit board 16.

A conductor pattern 24 is also formed on the same surface of the printed circuit board 16 as the chip antenna 22. A metal plate antenna contact 25 is formed at one end of the conductor pattern 24. The metal plate antenna contact 25 contacts the metal plate antenna 21 as explained below. A second through-hole 23b is also formed to the other end of the conductor pattern 24.

Meanwhile, a conductor pattern 24a is formed on the other surface of the printed circuit board 16 as illustrated in FIG. 4. The first through-hole 23a is connected to one end of the conductor pattern 24a, while the second through-hole 23b is connected to the other end. The conductor pattern 24a is formed in the shape of letter S and this shape maybe extended to extend the effective length of the conductor pattern 24a, or the circuit board antenna 20, as long as possible within the mobile phone.

Usually, wiring patterns are formed on the printed circuit board 16. The conductor patterns 24 and 24a of the present embodiment can be formed on the printed circuit board 16 with a means identical to such wiring patterns.

The conductor patterns 24 and 24a are connected to each other via the second through-hole 23b. Meanwhile, the conductor pattern 24a and chip antenna 22 are connected to each other via the first through-hole 23a. As explained above, the chip antenna 22, conductor pattern 24a and conductor pattern 24 are connected sequentially and continuously to form the circuit board antenna 20 as a whole. In addition, the conductor pattern 24/chip antenna 22 and the conductor pattern 24a are respectively allocated on different surfaces of the printed circuit board in order to effectively acquire the space for allocating the circuit board antenna 20.

The printed circuit board 16 is fixed between the front case 14 and the rear case 15 via a screwing portion 28.

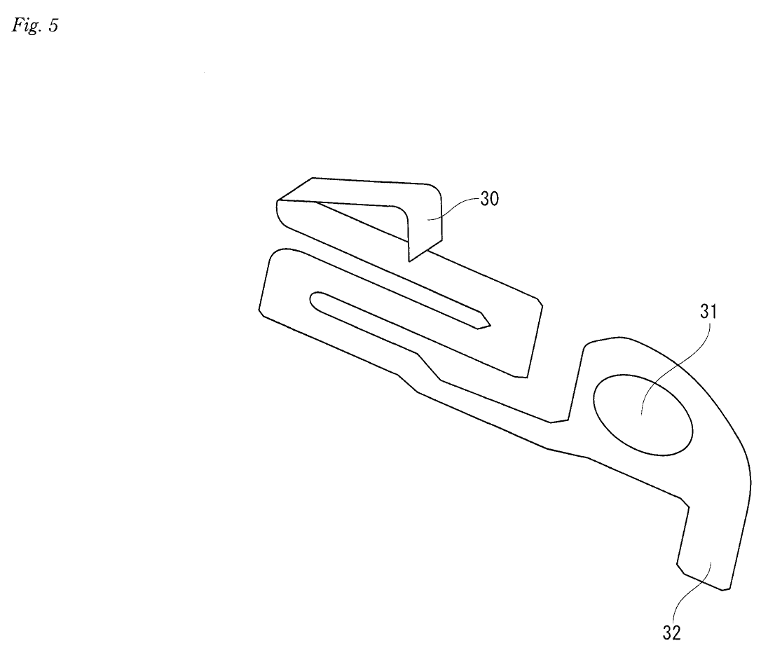

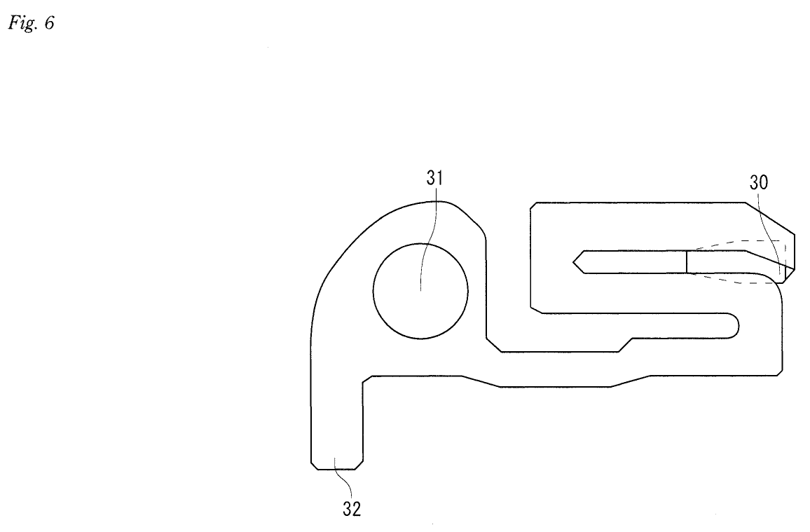

FIG. 5 is a perspective view of the metal plate antenna 21 of the present embodiment, while FIG. 6 is a front elevation of the metal plate antenna 21. The metal plate antenna 21 of the present embodiment is constituted with a sheet of metal plate.

A spring contact 30 is formed at one end of the metal plate antenna 21. The spring contact 30 is given the spring property by bending one end of the metal plate antenna 21. In FIG. 6, the spring contact 30 is indicated with a dotted line as the folding portion. On the other hand, the other end of the metal plate antenna 21 works as an antenna end portion 32. At the area near the antenna end portion 32, a screwing hole 31 is formed for fixing the metal plate antenna 21 to the enclosure.

In FIG. 2, the upper part of the rear case 15 is defined into a plurality of sections. Among these sections, sections of the second stage, or row, from the upper end of the rear case 15 accommodate the right and left speakers 11. The receiver 10 is accommodated in the left side of the uppermost row of the rear case 15 as shown in FIG. 2. A lead-out portion of the coaxial cable 18 extended from the lower enclosure 2 is provided at the lower area of the regions accommodating the speakers 11. Further, various circuit units including the camera unit 12 and others are mounted on the printed circuit board 16.

The metal plate antenna 21 of the present embodiment is accommodated in the vacant section in the right side of the uppermost row of the rear case 15. As explained above, the metal plate antenna 21 of the present embodiment is provided within a small gap in the enclosure at a location so as not to interfere with the other components.

The metal plate antenna 21 of the present embodiment is formed in the shape of a letter S as shown in FIG. 5 and FIG. 6. Accordingly, the effective length of antenna can be increased, and the conductor pattern 24a and the metal plate antenna 21 are able to be accommodated within the limited region of the upper enclosure 1.

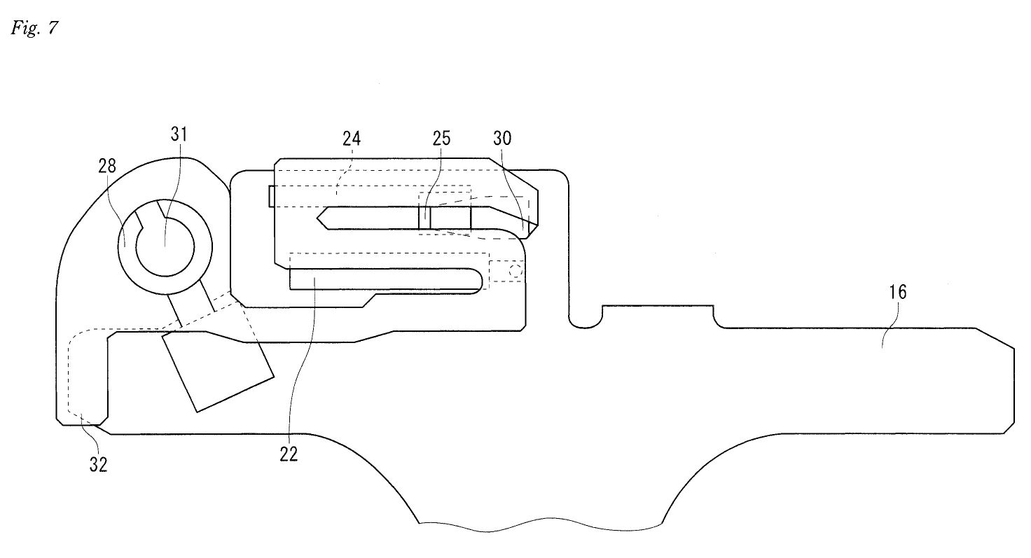

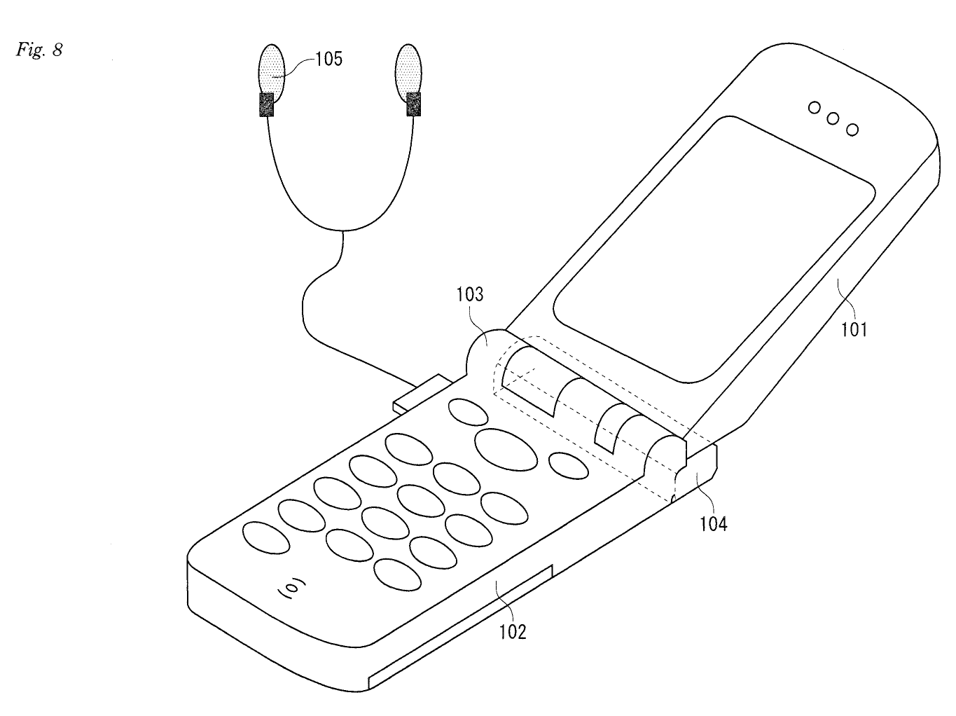

FIG. 7 shows the state where the metal plate antenna 21, printed circuit board 16, and circuit board antenna 20 of the present embodiment are connected. The screwing hole 31 of the metal plate antenna 21 is overlapped on the screwing hole 28 formed to the printed circuit board 16. The metal plate antenna 21 and the printed circuit board 16 are fixed with a screw 9 illustrated in FIG. 7 in the state being held between the front case 14 and the rear case 15.

On the other hand, the spring contact 30 of the metal plate antenna 21 is allocated at the location opposing to the metal plate antenna contact 25 formed on the printed circuit board 16, under the condition that one end of the metal plate antenna 21 is fixed to the printed circuit board 16. Since one end of the metal plate antenna 21 is fixed to the printed circuit board 16, the spring contact 30 and the metal plate antenna contact 25 are electrically contact with each other, and thereby the metal plate antenna 21 and the circuit board antenna 20 form an integrated low frequency antenna 6. The effective length of the low frequency antenna 6 can be further extended, by connecting the metal plate antenna 21 and the circuit board antenna 20.

The metal plate antenna 21 is allocated as overlapping the circuit board antenna 20 formed on the printed circuit board 16. The space for accommodating the low frequency antenna 6 can be acquired effectively through three-dimensional allocation of the antenna.

The mobile phone does not ensure sufficient allowance within the enclosure for additional new components because it is basically designed compact in size. However, use of the antenna of the present embodiment allows for effective allocation of a low frequency antenna having the required effective length within a small space of the enclosure of the mobile phone.

As explained above, the low frequency antenna of the present embodiment is mounted within the upper enclosure of the mobile phone, in which the liquid crystal display is mounted. Therefore, it is possible to mount the low frequency antenna at the portion of the mobile terminal where a user of the mobile phone rarely holds the mobile phone while it is in operation. Accordingly, the possibility of disturbance to antenna impedance by a human body and deterioration of radiation efficiency there from is lowered.

Moreover, the mobile phone of the present embodiment is capable of accommodating the low frequency antenna within the limited space of the enclosure by utilizing a dead space in the upper enclosure. Particularly, a problem in antenna allocation can be solved effectively, and the required effective length of the antenna can be attained by combining a plurality of antenna elements of different types, such as a chip antenna, conductor pattern formed on the printed circuit board and metal plate antenna, in three dimensions, as explained above. Therefore, it is no longer required to mount an external antenna element outside of the mobile phone, and transmission and reception can be realized by utilizing the low frequency bands such as FM broadcast without any deterioration of compactness in enclosure design.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An antenna mounted in a wireless apparatus, comprising:
a conductor pattern formed on at least one surface of a printed circuit board of the wireless apparatus;
a chip antenna mounted on one surface of the printed circuit board connected with the conductor pattern; and
a metal plate antenna allocated within an enclosure of the wireless apparatus making a contact with one end of the conductor pattern.

2. The antenna according to claim 1, wherein:
the conductor pattern includes a first conductor pattern formed on a first surface of the printed circuit board, and a second conductor pattern formed on a second surface of the printed circuit board;
one end of the first conductor pattern and one end of the second conductor pattern are connected via a through hole formed on the printed circuit board.

3. The antenna according to claim 1, wherein:
the conductor pattern is formed on the first surface of the printed circuit board;
the chip antenna is located on the second surface of the printed circuit board; and
one end of the conductor pattern and one end of the chip antenna are connected via a through hole formed on the printed circuit board.

4. The antenna according to claim 1, wherein:
the metal plate antenna includes a first contact portion, located at the one end of the metal plate, having a spring property; and
the conductor pattern includes a second contact, located at the one end of the conductor pattern in contact with the first contact.

5. A wireless terminal comprising:
a circuit board in which circuits are mounted;
a conductor pattern formed on the circuit board;
a chip antenna mounted on the circuit board; and
a metal plate antenna formed of a metal plate;
wherein the chip antenna, the conductor pattern, and the metal plate antenna are connected in series to constitute a built-in antenna.

6. The wireless terminal according to claim 5, wherein:
the conductor pattern is formed on the first surface of the circuit board;
the chip antenna is formed on the second surface of the circuit board; and
one end of the conductor pattern and one end of the chip antenna are connected via a through hole formed on the circuit board.

7. The wireless terminal according to claim 5, wherein:
the conductor pattern has a first conductor pattern formed on a first surface of the circuit board, and a second conductor pattern formed on a second surface of the circuit board, and
the first conductor pattern and the second conductor pattern are connected via a through hole formed on the circuit board.

8. The wireless terminal according to claim 5, further comprising:
a first enclosure in which a manipulating unit to be manipulated by a user is formed thereon; and
a second enclosure supported to the first enclosure in an openable and a closable manner;
wherein the build-in antenna is accommodated within the second enclosure.

9. The terminal according to claim 8, wherein the wireless terminal is a mobile phone;
the second enclosure comprising a receiver for outputting sound generated from audio signals transmitted from another wireless apparatus; and
the built-in antenna is allocated at the area of the second enclosure that is close to the location where the receiver is allocated.

10. The terminal according to claim 5, wherein the built-in antenna is a short-wavelength bands antenna.

11. An information terminal comprising:
an enclosure;
a circuit board accommodated within the enclosure;
a circuit board antenna formed on the circuit board; and
a second antenna placed over the circuit board antenna, and having a contact portion that making a contact with the circuit board antenna.

12. The information terminal according to claim 11, further comprising:
a conductor pattern formed on the circuit board.
